(19) United States
(12) Patent Application Publication
(10) Pub. No.: US 2010/0215995 A1
(43) Pub. Date: Aug. 26, 2010

(54) MAGNETIC STATE OF CHARGE SENSOR FOR A BATTERY

(75) Inventors: Peter J. Hopper, San Jose, CA (US); Kyuwoon Hwang, Palo Alto, CA (US); Ali Djabbari, Saratoga, CA (US); William French, San Jose, CA (US); Qingguo Liu, Santa Clara, CA (US)

Correspondence Address: Munck Carter/NSC, P.O. Drawer 800889, Dallas, TX, 75380, US

(73) Assignee: National Semiconductor Corporation, Santa Clara, CA (US)

(21) Appl. No.: 12/703,650

(22) Filed: Feb. 10, 2010

Related U.S. Application Data
(60) Provisional application No. 61/207,299, filed on Feb. 10, 2009.

(51) Int. Cl. H01M 2/00; H01M 10/48; H01M 6/00; G01N 27/416

(52) U.S. Cl. 429/10; 429/92; 429/122; 324/430

(57) ABSTRACT

A battery includes multiple conductive battery plates and a complex electrolytic material located between the conductive battery plates. The battery also includes a conductive sensor wire located within the complex electrolytic material. The conductive sensor wire may be configured to generate a magnetic field within the complex electrolytic material based on an electrical signal flowing through the conductive sensor wire. The battery may further include a temperature sensor wire within the complex electrolytic material.

### CROSS-REFERENCE TO RELATED APPLICATION AND PRIORITY CLAIM

This application claims priority under 35 U.S.C. §119(e) to U.S. Provisional Application No. 61/207,299 filed on Feb. 10, 2009, which is hereby incorporated by reference.

### TECHNICAL FIELD

This disclosure is generally directed to battery charge sensors. More specifically, this disclosure relates to a magnetic state of charge sensor for a battery.

### BACKGROUND

Modern batteries, such as lithium iron phosphate batteries, combine high power density and high energy density. It is very useful to be able to determine the state of charge (SOC) of such a battery. However, it is very difficult to accurately determine the state of charge for a battery due to the flatness of the voltage-SOC curve. Conventional methods, such as charge counting, cannot provide an accurate measurement due to low resolution current sensing and error accumulation.

### BRIEF DESCRIPTION OF THE DRAWINGS

For a more complete understanding of this disclosure, reference is now made to the following description, taken in conjunction with the accompanying drawings, in which:

FIG. 1 illustrates an example graph plotting relative permeability of a permeable electrolytic medium of a battery as a function of a state of charge of the battery according to this disclosure;

FIGS. 2A and 2B illustrate an example insulated conductive sensor wire of a magnetic sensor wound through a permeable electrolytic medium of a battery according to this disclosure;

FIGS. 3A and 3B illustrate an example battery with a permeable electrolytic medium having an embedded insulated conductive sensor wire according to this disclosure;

FIG. 4 illustrates an example battery having multiple battery plates through which an insulated conductive sensor wire has been wound according to this disclosure;

FIGS. 5 and 6 illustrate an example magnetic field that surrounds an insulated conductive sensor wire when an electrical current signal is flowing through the insulated conductive sensor wire according to this disclosure;

FIGS. 7 and 8 illustrate an example insulated conductive sensor wire embedded within a portion of a permeable electrolytic medium of a battery according to this disclosure;

FIG. 9 illustrates an example state of charge test unit according to this disclosure;

FIG. 10 illustrates an example process for providing a magnetic state of charge of a battery according to this disclosure;

FIGS. 11 through 13 illustrate example graphs involving an inductance of an insulated conductive sensor wire and a relative permeability of a permeable electrolytic medium of a battery according to this disclosure;

FIG. 14 illustrates an example battery having a permeable electrolytic medium with an insulated conductive sensor wire and a temperature sensor wire according to this disclosure;

FIG. 15 illustrates an example battery having multiple embedded sensor wire coils according to this disclosure;

FIG. 16 illustrates an example battery having multiple sensor wire coils and a temperature sensor wire according to this disclosure;

FIG. 17 illustrates an example gasoline powered vehicle having a battery with an embedded insulated conductive sensor wire according to this disclosure;

FIG. 18 illustrates an example gasoline-electric hybrid vehicle having multiple batteries according to this disclosure; and

FIG. 19 illustrates an example system having a battery-powered machine and multiple batteries each with an embedded insulated conductive sensor wire according to this disclosure.

### DETAILED DESCRIPTION OF THE INVENTION

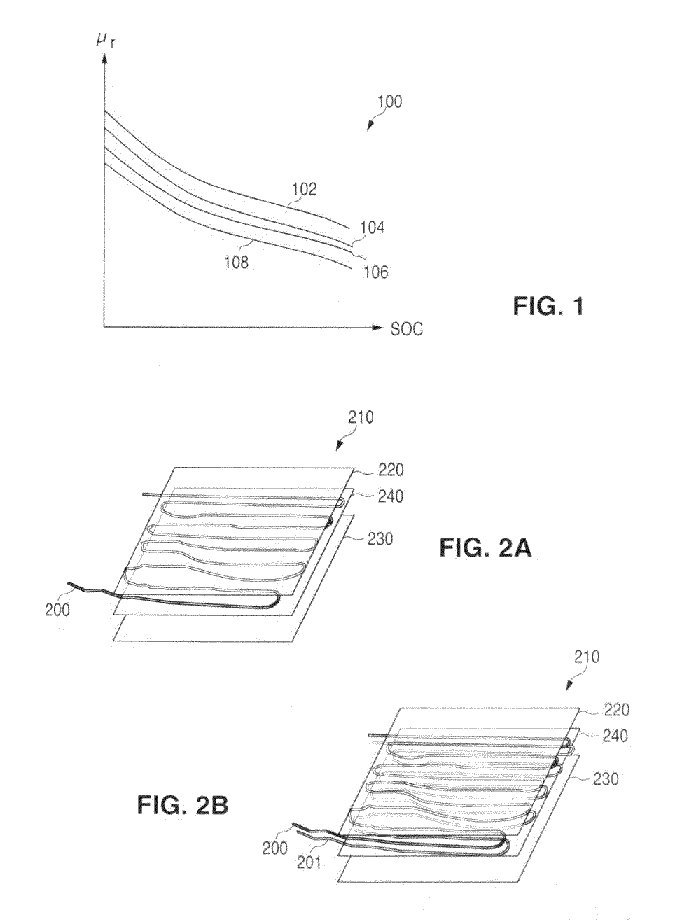

FIGS. 1 through 19 and the various embodiments used to describe the principles of the present invention in this patent document are by way of illustration only and should not be construed in any way to limit the scope of the invention. Those skilled in the art will understand that the principles of the present invention may be implemented in any type of suitably arranged battery circuit. To simplify the drawings, reference numerals from previous drawings will sometimes not be repeated for structures that have already been identified.

FIG. 1 illustrates an example graph 100 plotting relative permeability (μᵣ) of a permeable electrolytic medium of a battery as a function of a state of charge (SOC) of the battery according to this disclosure. More specifically, the graph 100 plots the relative permeability of the permeable electrolytic material as a function of the battery's SOC at four different temperatures 102-108. Lower values of the SOC are correlated with higher values of relative permeability, and higher values of the SOC are correlated with lower values of relative permeability. As shown in FIG. 1, the actual relationship between the SOC and the relative permeability is dependent upon the ambient temperature.

FIG. 2A illustrates an example insulated conductive sensor wire 200 of a magnetic sensor wound through a permeable electrolytic medium of a battery according to this disclosure. The electrolytic material is disposed between a conductive plate 220 (such as an aluminum plate) and an ion membrane 240 of an SOC battery 210. Additional electrolytic material can be disposed between the ion membrane 240 and a conductive plate 230 (such as a copper plate) of the SOC battery 210. The electrolytic material can be a complex electrolytic material with a frequency dependent impedance. In some embodiments, the conductive sensor wire 200 is made of copper material. However, other conductive material(s) may also be used in the sensor wire 200.

As shown in FIG. 2A, the conductive sensor wire 200 is wound through the permeable electrolytic medium. Winding the conductive sensor wire 200 through the permeable electrolytic medium can create an inductance when a voltage or current is applied to the conductive sensor wire 200. The sensor wire 200 is wound back and forth between the conductive plate 220 and the ion membrane 240 of the SOC battery 210. During the manufacturing process of the SOC battery 210, the sensor wire 200 is embedded in the permeable electrolytic material formed between the conductive plate 220 and the ion membrane 240.

FIG. 2B illustrates an example insulated conductive sensor wires 200, 201 of a magnetic sensor wound through a permeable electrolytic medium of a battery according to this disclosure. In some embodiments, the SOC battery 210 includes at least two sensor wires 200, 201 as shown in FIG. 2B. The second conductive sensor wire 201 also is wound through the permeable electrolytic medium. Winding the second conductive sensor wire 201 through the permeable electrolytic medium can create a capacitance between the conductive sensor wires 200, 201 when a voltage or current is applied to the conductive sensor wires 200, 201.

In some embodiments, the conductive sensor wires 200, 201 are formed from conductive tape. In other embodiments, the SOC battery 210 includes one or more conductive plates instead of, or in conjunction with, the conductive sensor wires 200, 201.

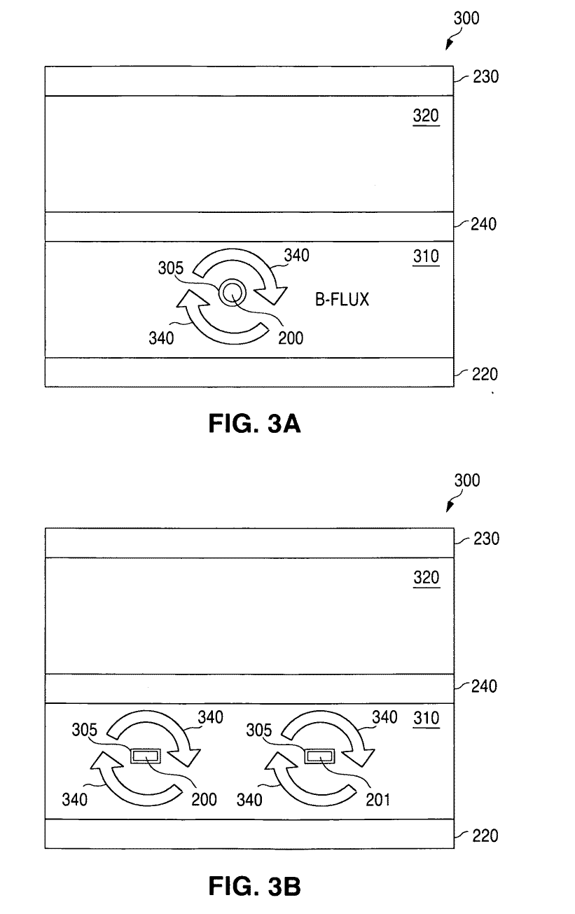

FIG. 3A illustrates an example battery 300 with a permeable electrolytic medium having an embedded insulated conductive sensor wire 200 according to this disclosure. The insulated conductive sensor wire 200 is embedded in a permeable electrolytic medium 310 between the conductive plate 220 and the ion membrane 240. The conductive sensor wire 200 includes an insulating material 305, such as 10 μm polyurethane insulation disposed around the conductive sensor wire 200. In other embodiments, the insulating material 305 is a 1 Å polyurethane insulation disposed around the conductive sensor wire 200. In yet other embodiments, the conductive sensor wire 200 does not include insulating material 305, and the conductive sensor wire 200 is a bare wire.

As shown in FIG. 3A, another body of permeable electrolytic material 320 exists between the ion membrane 240 and the conductive plate 230. In other embodiments, the insulated conductive sensor wire 200 may be embedded in the permeable electrolytic material 320 instead of the permeable electrolytic material 310.

In other embodiments as shown in FIG. 3B, the battery 300 includes a second insulated conductive sensor wire 201. The second conductor wire 201 may be embedded in the permeable electrolytic material 320 instead of the permeable electrolytic material 310.

As shown in FIG. 3B, the insulated conductive wires 200, 201 can comprise an insulated conductive tape. The conductive sensor wire 201 includes an insulating material 305, such as 10 μm polyurethane insulation disposed around the conductive sensor wire 201. In other embodiments, the insulating material 305 is a 1 Å polyurethane insulation disposed around the conductive sensor wire 200. In yet other embodiments, the conductive sensor wire 201 does not include insulating material 305, and the conductive sensor wire 201 is a bare wire. In still other embodiments, the battery 300 includes one or more conductive plates instead of, or in conjunction with, the conductive sensor wires 200, 201.

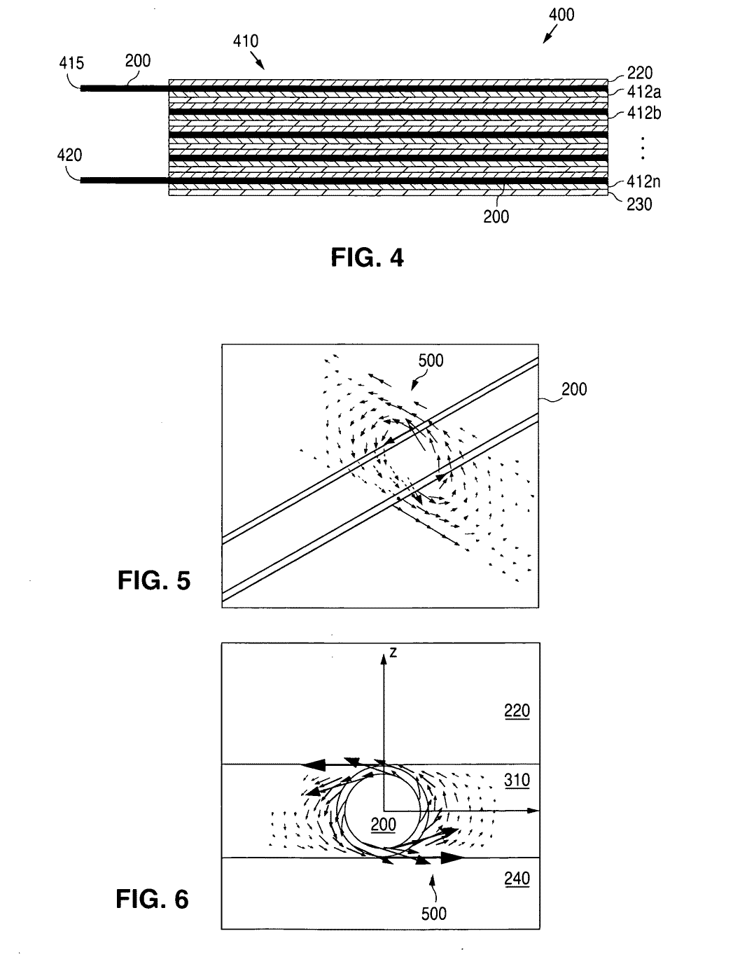

In yet other embodiments, the insulated conductive sensor wire 200 may be embedded in both the permeable electrolytic material 310 and the permeable electrolytic material 320. For example, the insulated conductive sensor wire 200 may be embedded in one layer of permeable electrolytic material 310 as shown in FIG. 3A and then extend into other levels of permeable electrolytic material. An example of this is shown in FIG. 4.

FIG. 4 illustrates an example battery 400 having multiple battery plates 410 through which an insulated conductive sensor wire has been wound according to this disclosure. For example, the battery plates 410 can form an SOC battery that has been created via a rolled and flattened process.

A first terminal end 415 of the insulated conductive sensor wire 200 enters a first layer of permeable electrolytic material 412a. The insulated conductive sensor wire 200 is wound through the first layer of permeable electrolytic material 412a. The insulated conductive sensor wire 200 is then wound through successive layers of permeable electrolytic material 412b-412n. A second terminal end 420 of the insulated conductive sensor wire 200 exits the last layer of permeable electrolytic material 412n. The battery plates 410 containing the insulated conductive sensor wire 200 are placed into an SOC battery 400. An SOC battery that contains the insulated conductive sensor wire 200 (such as an insulated copper sensor wire) is adapted for state of charge testing according to this disclosure.

As will be described more fully below, the first terminal end 415 and the second terminal end 420 of the insulated conductive sensor wire 200 are adapted to be connected to a state of charge test unit. The state of charge test unit is used to send an alternating current (AC) electrical current signal through the conductive sensor wire 200. A magnitude of the electrical current signal can be on the order of several milliamperes, for example. The electrical current signal causes the conductive sensor wire 200 to create an internal distributed magnetic field around the conductive sensor wire 200 in the body of the permeable electrolytic medium 310 (as illustrated in FIG. 3 by B-Flux 340).

FIGS. 5 and 6 illustrate an example magnetic field 500 that surrounds an insulated conductive sensor wire 200 when an electrical current signal is flowing through the insulated conductive sensor wire 200 according to this disclosure. In particular, FIG. 5 illustrates a perspective view of the magnetic field 500. As shown in FIG. 5, the direction and relative intensity of the magnetic field 500 are represented by arrows. Here, the magnetic field 500 is concentric around the axis of the conductive sensor wire 200.

FIG. 6 illustrates a cross-sectional view of the magnetic field 500. In the example illustrated in FIG. 6, the conductive sensor wire 200 is located in the electrolytic material and is in contact with a conductive plate (e.g., aluminum conductive plate 220) on one side and in contact with an ion membrane 240 on the other side.

As current is applied to the conductive sensor wire 200, the magnetic field 500 is generated. The magnetic field 500 is generally concentric around the axis of the conductive sensor wire 200. However, a field line restriction occurs at the surface of the conductive plate (such as the conductive plate 220) and at the surface of the ion membrane 240. Accordingly, the magnetic field 500 can be substantially limited in the conductive plate 220 and the ion membrane 240.

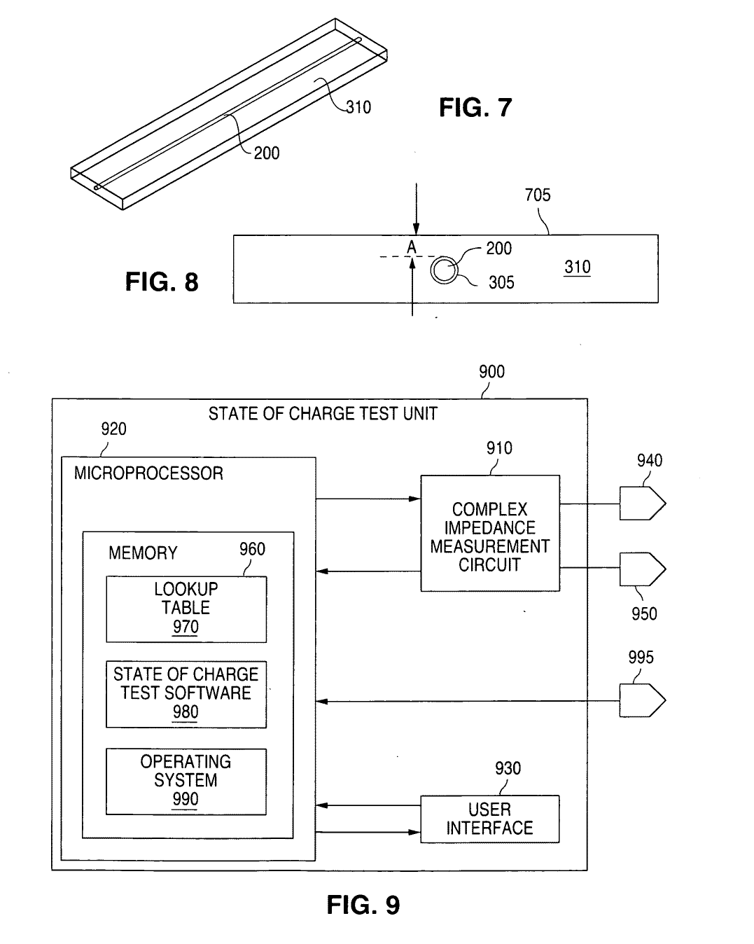

FIGS. 7 and 8 illustrate an example insulated conductive sensor wire 200 embedded within a portion of a permeable electrolytic medium 310 of a battery according to this disclosure. In particular, FIG. 7 illustrates a perspective view of a portion of the insulated conductive sensor wire 200 embedded within a portion of the permeable electrolytic medium 310. In some embodiments, the insulated conductive sensor wire 200 includes a conductive wire dimensioned to have a diameter of approximately 100 μm covered with a polyurethane or nylon insulation that is dimensioned to be approximately 10 μm thick. In other embodiments, the diameter of the conductive sensor wire 200 is in a range of approximately 10 μm to approximately 17 μm, and the thickness of the polyurethane or nylon insulating material 305 is approximately 1 μm. In some embodiments, the thickness of the polyurethane or nylon insulating material 305 is approximately 1 Å. The thickness of the electrolytic medium 310 could be approximately 100 μm.

FIG. 8 illustrates a cross-sectional view of the insulated conductive sensor wire 200 that is shown in FIG. 7. In some embodiments, the insulated conductive sensor wire 200 is embedded in the center of the permeable electrolytic medium 310. The letter “A” designates a distance between a top surface 705 of the permeable electrolytic medium 310 and the adjacent insulating material 305 of the insulated conductive sensor wire 200.

FIG. 9 illustrates an example state of charge test unit 900 according to this disclosure. The state of charge test unit 900 includes a complex impedance measurement circuit 910, a microprocessor 920, and a user interface unit 930. The complex impedance measurement circuit 910 includes a first input port 940 that connects to a first end 415 of the insulated conductive sensor wire 200 and a second input port 950 that connects to a second end 420 of the insulated conductive sensor wire 200.

The microprocessor 920 is connected to the complex impedance measurement circuit 910. The user interface unit 930 is connected to the microprocessor 920. The microprocessor 920 can include a memory 960. The memory 960 includes a state of charge look-up table (LUT) 970, a state of charge test software module 980, and an operating system 990.

Together, the microprocessor 920, the state of charge look-up table 970, the operating system 990, and the state of charge test software module 980 comprise a state of charge processor that is capable of carrying out a state of charge test function for a battery. The state of charge test unit 900 can determine the state of charge for a battery without relying upon a voltage measured at positive and negative terminals of the battery.

In some embodiments, the state of charge test unit 900 can store two or more reference state values. For example, the state of charge test unit 900 can include reference state values that correspond to a maximum charge, a half charge, and a low charge. It will be understood that illustration of these three reference states is for example purposes only and that other numbers of reference states could be used without departing from the scope of this disclosure.

In some embodiments, the LUT 970 is preconfigured and stored in the memory 960. In other embodiments, the LUT 970 is constructed by the state of charge test unit 900. For example, the state of charge test unit 900 may construct the LUT 970 at startup. As a particular example, the state of charge test unit 900 could perform a frequency sweep measurement of the battery at known states of charge to construct the LUT 970. A first measurement cycle could be performed across a frequency sweep, such as 10 MHz, 12 MHz, 14 MHz, 16 MHz, 18 MHz and 20 MHz, at a specified state of charge of the battery, such as 20% charged. It will be understood that illustration of these frequency values is for example purposes only and that other frequency values could be used without departing from the scope of this disclosure. The first measurement can also be performed across a range of temperatures of the battery such that measurement values are collected at different temperatures and different frequencies. A second measure cycle could be performed across the frequency sweep, such as 10 MHz, 12 MHz, 14 MHz, 16 MHz, 18 MHz and 20 MHz, at a different state of charge of the battery, such as 80% charged. The second measurement can also be performed across a range of temperatures of the battery such that measurement values are collected at different temperatures and different frequencies. The state of charge test unit 900 constructs the LUT 970 from the measured values from the first and second measurement cycles.

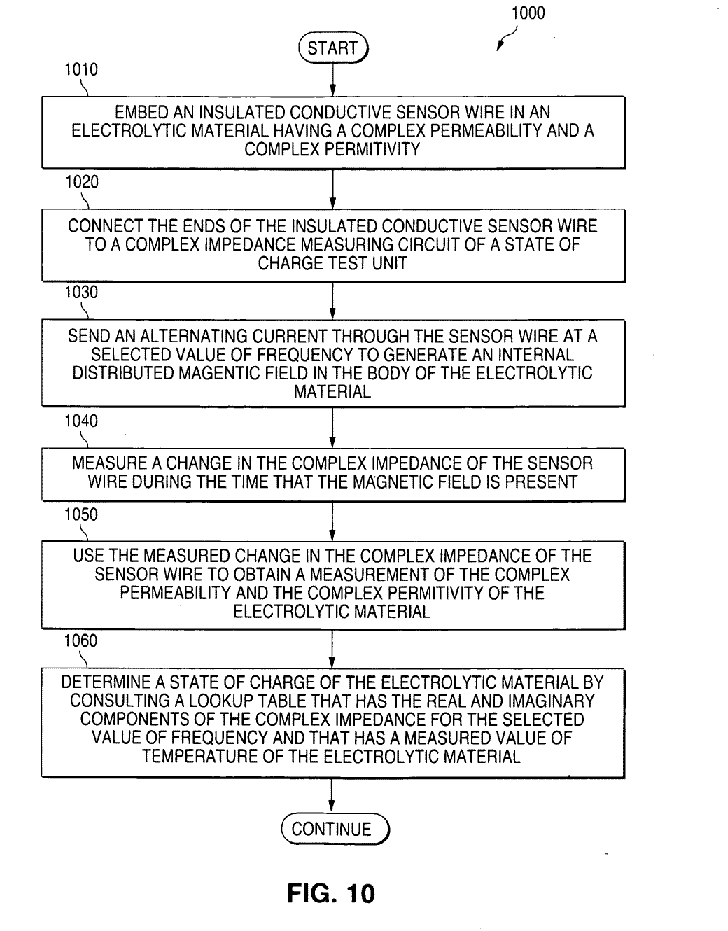

FIG. 10 illustrates an example process 1000 for providing a magnetic state of charge of a battery according to this disclosure. In block 1010, during a manufacturing process of a battery, an insulated conductive sensor wire 200 is embedded in an electrolytic material 310 and/or 320 having a complex permeability and a complex permittivity. In block 1020, the ends of the insulated conductive sensor wire 200 are connected to a complex impedance measurement circuit 910 of a state of charge test unit 900. Thereafter, in block 1030, the complex impedance measuring circuit 910 sends an AC electrical current signal (such as a radio frequency or “RF” signal) through the sensor wire 200 at a specific selected frequency to generate an internal distributed magnetic field in the body of the electrolytic material 310 and/or 320. Since the RF signal is influenced by the electrolytic material at different frequencies, the RF signal can be a swept frequency RF signal that varies in frequency from approximately one kilohertz to one hundred megahertz. Additionally, the AC signal can be applied at different power levels.

In block 1040, the complex impedance measuring circuit 910 measures a change in the complex impedance of the sensor wire 200 during the time that the magnetic field is present in the body of the electrolytic material 310 and/or 320. Here, the sensor wire 200 represents an inductor.

The measurement can be a single measurement or two or more measurements at different temperatures and/or frequencies. For example, the measurement can be a single measurement at one temperature and one frequency. As another example, the measurements could include measurements at one temperature at two or more frequencies across a frequency sweep. As yet another example, the measurements could include measurements at different temperatures and at one or more frequencies across the frequency sweep.

The measurement can be performed across the same frequency sweep used to generate the LUT 970. The frequencies used for the measurement follow the same frequency sweep or curve as the frequencies used to generate the LUT 970. However, the frequencies used for the measurement need not match the frequencies used to generate the LUT 970. For example, the measurement can be performed at 11 MHz, 13 MHz, 15 MHz, 17 MHz, 19 MHz and 21 MHz.

At high frequencies, there will be an impedance of the inductor. The high impedance of the inductor includes a complex component and a real component. The complex component is pure inductance, and the real component relates to the resistance plus all the losses associated with the system. The complex impedance measuring circuit 910 measures both the complex impedance and the real component of impedance. These values are provided to the microprocessor 920.

The inductance of the sensor wire 200 at high frequencies can depend on the nature of the permeable electrolytic material 310 and/or 320. High values of permeability of the electrolytic material 310 and/or 320 can correspond to high inductance values. Additionally, high values of permittivity of the electrolytic material 310 and/or 320 can correspond to low inductance values.

In block 1050, the microprocessor 920 uses the measured change in the complex impedance of the sensor wire 200 to obtain a measurement of the complex permeability and complex permittivity of the electrolytic material 310 and/or 320. The microprocessor 920 determines a state of charge of the electrolytic material 310 and/or 320 by consulting a look-up table 970 that includes real and imaginary components of the complex impedance and a value of the measured temperature of the electrolytic material 310 and/or 320 for the specific selected frequency.

In some embodiments of the battery and battery test system, the state of charge test unit 900 determines a state of charge of the electrolytic material 310 and/or 320 using the real component of impedance. The state of charge that corresponds to a real component of impedance can be empirically determined and that information can be stored in the look-up table 970. The microprocessor 920 of the state of charge test unit 900 is then able to subsequently use measured values of the real component of impedance to determine the corresponding state of charge in the electrolytic material 310.

The correlations between the values of complex permeability and complex permittivity and the values of state of charge may be non-linear. The microprocessor 920 accesses the look-up table 970 that can contain empirically determined correlations between the values of the complex permeability and complex permittivity and the values of the state of charge. Because the values of the complex permeability and complex permittivity are temperature dependent, the look-up table 970 also can contain empirically determined correlations for different temperature values. The look-up table 970 may further contain the empirically determined correlations for different values of frequency. The use of additional frequencies increases the accuracy of the determination of the state of charge.

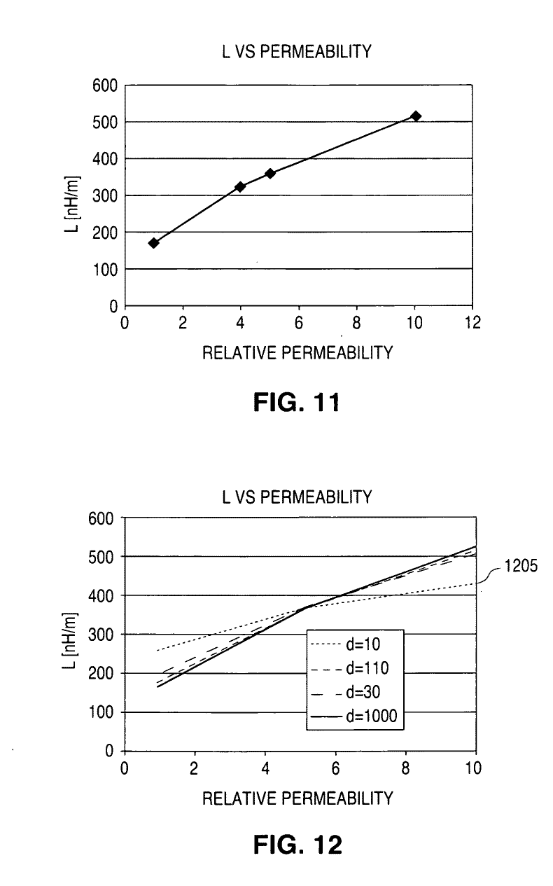

FIGS. 11 through 13 illustrate example graphs involving an inductance of an insulated conductive sensor wire 200 and a relative permeability of a permeable electrolytic medium 310 and/or 320 of a battery according to this disclosure. In particular, FIGS. 11 and 12 illustrate graphs 1100 and 1200 that relate the values of the inductance of the insulated conductive wire 200, such as an insulated copper sensor wire, to values of relative permeability of the electrolytic medium 310 and/or 320 for an AC electrical signal value of 100 MHz.

In the example illustrated in FIG. 11, the insulated conductive sensor wire 200 includes a copper wire dimensioned to have a diameter from approximately 10 μm to approximately 100 μm. The insulated conductive sensor wire 200 can be covered with an insulating material 305, such as a polyurethane or nylon insulator, which is dimensioned to have a thickness from approximately 1 μm to approximately 10 μm. The distance between the copper of the sensor wire 200 and the conductive plate 220 can be approximately 100 μm. As shown in FIG. 11, the inductance of the sensor wire 200 increases with increasing values of relative permeability.

The graph 1200 relates the values of the inductance of an insulated sensor wire 200 to values of relative permeability of the permeable electrolytic medium 310 and/or 320 for an AC electrical signal value of 100 MHz. As in the case of FIG. 11, the sensor wire 200 comprises copper wire dimensioned to include a diameter from approximately 10 μm to approximately 100 μm, which is covered with a polyurethane or nylon insulating material 305 that is dimensioned to have a thickness of from approximately 1 μm to approximately 10 μm.

In FIG. 12, measurements are shown for four different distances between the copper of the sensor wire 200 and the conductive plate 220. The largest distance is approximately 1000 μm, and the smallest distance is approximately 10 μm. At a distance of 10 μm, the polyurethane or nylon insulating material 305 touches the conductive plate 220. As shown by line 1205, this distance (10 μm) is the least sensitive but is still sensitive enough to detect an inductance change.

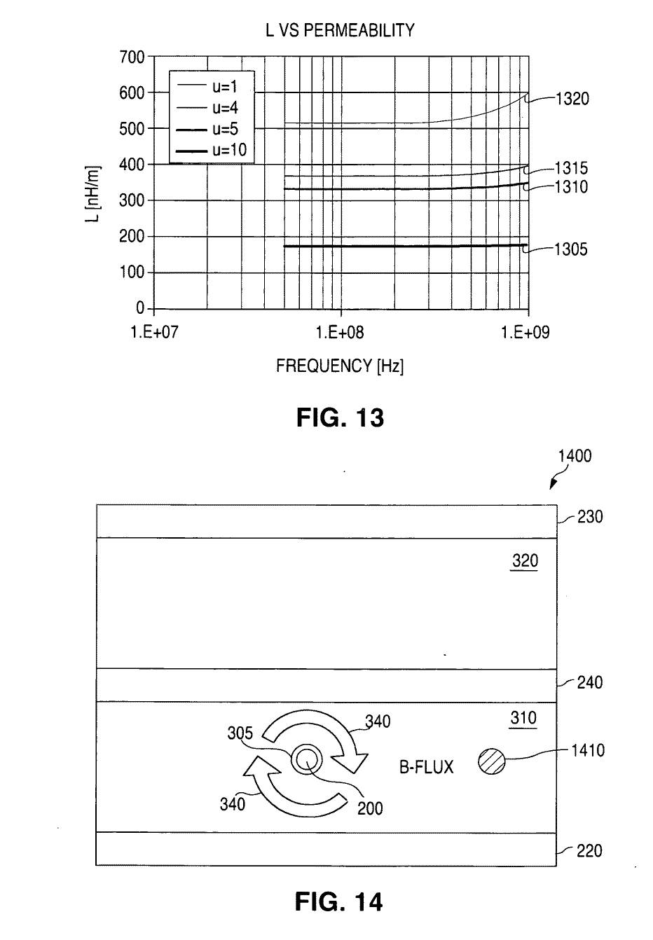

FIG. 13 illustrates a graph 1300 that relates the values of the inductance of the insulated conductive sensor wire 200 to values of frequency for four values of relative permeability of the permeable electrolytic medium 310 and/or 320. The four values of relative permeability are one (line 1305), four (line 1310), five (line 1315), and ten (line 1320). The values of relative permeability are dimensionless values. As shown in FIG. 13, the values of relative permeability do not vary greatly with changes in frequency.

As described above, the complex permeability of a permeable electrolytic material varies with changes in temperature. Therefore, the state of charge test unit 900 can utilize information concerning the temperature of the permeable electrolytic material to determine the state of charge of the battery. As shown in FIG. 9, the state of charge test unit 900 includes a temperature information input port 995 that receives temperature information. The temperature information that is received at the input port 995 is provided to the microprocessor 920.

In some embodiments, the temperature of the permeable electrolytic material is obtained from a temperature sensor wire that is embedded in the permeable electrolytic material in the same manner as the insulated conductive sensor wire 200. FIG. 14 illustrates an example battery 1400 having a permeable electrolytic medium 310 with an insulated conductive sensor wire 200 and a temperature sensor wire 1410 according to this disclosure. The temperature sensor wire 1410 can measure a temperature of the permeable electrolytic medium 310. The temperature sensor wire 1410 is connected to the temperature information input port 995 that is shown in FIG. 9.

The temperature sensor wire 1410 can be used to detect an increase in the temperature of the electrolytic material 310, such as in a thermal run-away (discussed in more detail below). The temperature sensor 1410 can provide an indication to the state of charge test unit 900 that a thermal run-away condition is imminent or occurring. In some embodiments, the look-up table 970 includes temperature information for use in the detection of thermal run-away.

In some embodiments, the temperature sensor 1410 can be used to determine a state of charge when charging the battery. The temperature sensor 1410 can monitor the temperature of a battery as the battery is charged. Accordingly, the temperature sensor 1410 can provide temperature readings during a charge to a charging unit (not shown) to regulate the charging duration. For example, the temperature sensor 1410 can provide the temperature readings to a charging unit and, in response to the charging unit determining that the battery is fully charged, the charging unit ceases the charging operation. In some embodiments, the look-up table 970 includes temperature information for use in the charging operation.

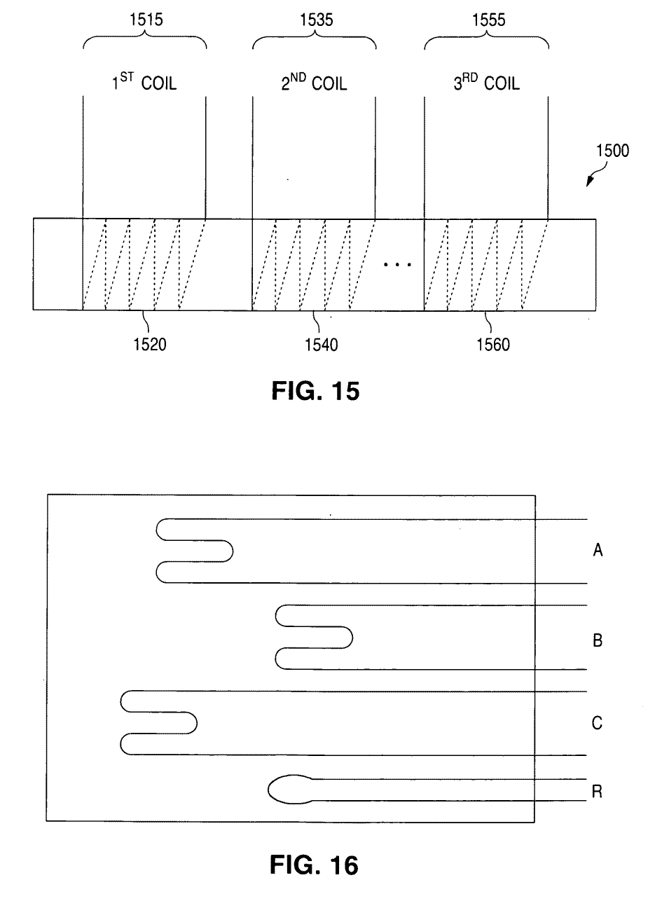

This disclosure is not limited to the use of a conductive sensor wire 200 with one coil. In some embodiments, multiple coils of the conductive sensor wire 200 may be used simultaneously. FIG. 15 illustrates an example battery 1500 having multiple embedded sensor wire coils according to this disclosure. A first coil 1515 of sensor wire is wound within a first portion 1520 of battery plates. A second coil 1535 of sensor wire is wound within a second portion 1540 of the battery plates. An “Nth” coil of sensor wire 1555 is wound within an “Nth” portion 1560 of battery plates. Each coil 1515, 1535, and 1555 may be independently operated to measure the state of charge of its respective portion of the battery plates of the battery.

FIG. 16 illustrates an example battery having multiple sensor wire coils (A, B, C) and a temperature sensor wire (R) according to this disclosure. The three sensor wire coils (A, B, C) can determine a state of charge of the battery at their respective locations. The temperature sensor wire (R) measures the temperature of the battery. The measurements are provided to the state of charge test unit 900 in the manner that has been previously described.

The battery test system's measurement of the complex permeability of the permeable electrolytic material is used to determine a state of charge in the permeable electrolytic material. The measurement of the complex permeability determines both the complex impedance and the real component of impedance.

In some embodiments of the battery and battery test system, the state of charge test unit 900 determines a state of charge of the electrolytic material 310 and/or 320 using the real component of impedance. The state of charge that corresponds to a real component of impedance can be empirically determined and that information can be stored in the look-up table 970. The microprocessor 920 of the state of charge test unit 900 is then able to subsequently use measured values of the real component of impedance to determine the corresponding state of charge in the electrolytic material 310.

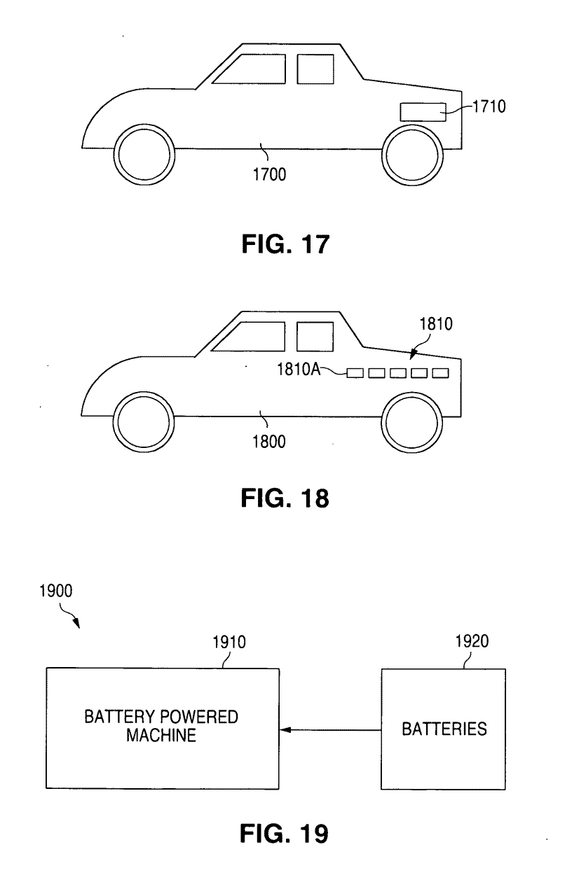

FIG. 17 illustrates an example gasoline powered vehicle 1700 having a battery 1710 with an embedded insulated conductive sensor wire according to this disclosure. The battery 1710 could have an embedded conductive sensor wire 200 and a state of charge test unit 900 described above.

FIG. 18 illustrates an example gasoline-electric hybrid vehicle 1800 having multiple batteries 1810 according to this disclosure. The vehicle 1800 includes a gasoline engine and electric motor (not shown). The vehicle 1800 also includes multiple batteries 1810. In some embodiments, the batteries 1810 can include a number of individual batteries adapted to be coupled in series and/or parallel. Also, in some embodiments, the batteries 1810 can include a number of battery cells assembled and coupled together as a single vehicle battery. Each battery 1810 could have an embedded conductive sensor wire 200 and a state of charge test unit 900 described above.

Where a conventional gasoline powered vehicle 1700 may include only one battery, gasoline-electric hybrid vehicles 1800 can include a significant number of batteries. It is very important that the electric charge on each of the batteries be maintained within an appropriate range. If the charge on a battery is too high or too low, the battery may be damaged. For example, if a charge on a battery 1810a has a charge that is lower than the remaining batteries 1810, the battery 1810a can start to appear as a resistive load to the remaining batteries. As energy is delivered through the battery 1810a (now acting as a resistive load due to the lower charge state), the electrolytic material 310 begins to increase in temperature. As the electrolytic material 310 begins to increase in temperature, the resistive value of the battery 1810a increases. This condition is referred to as thermal run-away and can result in permanent and severe damage to the battery 1810a.

The battery test system may be used to conveniently and efficiently monitor the state of charge of each of multiple batteries 1810 in a vehicle 1800. In conventional battery stacks, it is difficult to determine the state of charge of a single battery due to the voltage divider effect of the other adjacent batteries. The battery and battery test system described above overcome this problem by allowing the state of charge of each battery to be quickly and easily determined.

FIG. 19 illustrates an example system 1900 with a battery-powered machine 1910 and multiple batteries 1920 each with an embedded insulated conductive sensor wire according to this disclosure. The battery-powered machine 1910 can be any machine adapted to receive direct current energy from a battery source. For example, the battery-powered machine 1910 can be coupled to or include the batteries 1920. Further, each battery 1920 contains an embedded insulated conductive sensor wire 200. As in the case of the vehicle 1800, it is difficult to use prior art methods to determine the state of charge of a single battery due to the voltage divider effect of the other adjacent batteries. The battery and battery test system described above overcome this problem by allowing the state of charge of each battery to be quickly and easily determined.

It may be advantageous to set forth definitions of certain words and phrases that have been used within this patent document. Terms and phrases such as “above,” “below,” “front side,” and “backside” when used with reference to the drawings simply refer to aspects of certain structures when viewed at particular directions and are not limiting. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a battery comprising:
multiple conductive battery plates;
a complex electrolytic material located between the conductive battery plates; and
a conductive sensor wire located within the complex electrolytic material; and
a test unit comprising an impedance measuring circuit coupled to the conductive sensor wire, the test unit configured to determine a state of charge of the battery based on a measurement of an impedance of the conductive sensor wire.

2. The system of claim 1, wherein the impedance measuring circuit is configured to:
provide an electrical signal to the conductive sensor wire in order to generate a magnetic field within the complex electrolytic material; and
measure the inductance of the conductive sensor wire when the magnetic field is present.

3. The system of claim 1, wherein the test unit is configured to:
measure the impedance of the conductive sensor wire at a first state of charge of the battery using a first plurality of frequencies within a frequency sweep; and
measure the impedance of the conductive sensor wire at a second state of charge of the battery using the first plurality of frequencies within the frequency sweep.

4. The system of claim 3, wherein the test unit is configured to measure the impedance of the conductive sensor wire using a second plurality of frequencies within the frequency sweep.

5. The system of claim 4, wherein the test unit is configured to use a measurement of a temperature of the complex electrolytic material to determine the state of charge of the battery.

6. The system of claim 1, wherein the battery comprises multiple portions of the complex electrolytic material.

7. The system of claim 1, wherein the test unit is configured to determine the state of charge of the battery based on a change in capacitance between the conductive sensor wire and at least one of:
one of the battery plates; and
a second conductive sensor wire located within the complex electrolytic material.

8. A battery comprising:
multiple conductive battery plates;
a complex electrolytic material located between the conductive battery plates; and
a conductive sensor wire located within the complex electrolytic material.

9. The battery of claim 8, further comprising:
a first terminal coupled to a first end of the conductive sensor wire; and
a second terminal coupled to a second end of the conductive sensor wire.

10. The battery of claim 8, wherein the conductive sensor wire is configured to generate a magnetic field within the complex electrolytic material based on an electrical signal flowing through the conductive sensor wire.

11. The battery of claim 8, wherein the conductive sensor wire comprises multiple coils.

12. The battery of claim 11, wherein:
a first of the coils is within a first permeable electrolytic material plate; and
a second of the coils is within a second permeable electrolytic material plate.

13. The battery of claim 8, wherein the conductive sensor wire comprises an insulation layer.

14. The battery of claim 8, further comprising:
a temperature sensor wire within the complex electrolytic material.

15. A method comprising:
applying an electrical signal to a conductive sensor wire located within a complex electrolytic material of a battery;
generating a magnetic field within the complex electrolytic material based on the electrical signal;
measuring a change in an impedance of the conductive sensor wire when the magnetic field is present; and
determining a state of charge of the battery based on the measured change in the impedance of the conductive sensor wire.

16. The method of claim 15, wherein determining the state of charge of the battery comprises consulting a look-up table, the look-up table comprising real and imaginary components of a complex impedance at selected frequency values within a frequency sweep.

17. The method of claim 16, further comprising constructing the look-up table by:
measuring the impedance of the conductive sensor wire at a first state of charge of the battery using the selected frequency values within the frequency sweep; and
measuring the impedance of the conductive sensor wire at a second state of charge of the battery using the selected frequency values within the frequency sweep.

18. The method of claim 17, further comprising:
measuring the impedance of the conductive sensor wire using different frequency values within the frequency sweep.

19. The method of claim 15, further comprising:
measuring a temperature of the complex electrolytic material.

20. The method of claim 19, further comprising:
using the measurement of the temperature of the complex electrolytic material to determine the state of charge of the battery.
